(19) United States
(12) Patent Application Publication
(10) Pub. No.: US 2007/0199829 A1
(43) Pub. Date: Aug. 30, 2007

(54) Application of tribologically active surface to a metal work-piece using electrochemical machining

(75) Inventors: Miguel Azevedo, Ann Arbor, MI (US); Paul Freemantle, Plymouth, MI (US); Warran Boyd Lineton, Ann Arbor, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul World Wide, Inc.

(21) Appl. No.: 11/364,401

(22) Filed: Feb. 28, 2006

(51) Int. Cl. B23H 3/00

(52) U.S. Cl. 205/652

(57) ABSTRACT

The invention provides a method for machining a work-piece. The method includes the step of disposing a surface of a work-piece and an electrode a predetermined distance apart. The method also includes the step of directing a flow of electrolyte between the surface and the electrode. The method also includes the step of applying a voltage across the surface and the electrode to machine the work-piece to generate a current. The method also includes the step of adding a first predetermined material to the flow of electrolyte to bind to the surface of the work-piece and leave a protective layer.

### BACKGROUND OF THE INVENTION

1. Field of the Invention

The invention relates to electrochemical machining of work-pieces.

2. Description of Related Art

Electrochemical machining (ECM) is a technique for machining metal work-pieces. A cathode is advanced towards an anodic work-piece in the presence of an electrolyte. A voltage is applied across the cathode and the work-piece to generate a current between the cathode and the work-piece. The current passes through the electrolyte and causes material to be removed electrolytically from the surface of the work-piece. This technique can be used for the machining irregularly shaped work-pieces such as dies and moulds, as well as irregularly shaped holes in metals which do not readily yield to mechanical cutting. Also, three-dimensional patterns can be applied to work-piece surfaces derived from a correspondingly shaped cathode. Generally, high currents are desirable to attain high rates of removal of material and the smaller the gap between the cathode and the work-piece the sharper is the machining definition which can be achieved.

### SUMMARY OF THE INVENTION

The invention provides a method for machining a work-piece. The method includes the step of disposing a surface of a work-piece and an electrode a predetermined distance apart. The method also includes the step of directing a flow of electrolyte between the surface and the electrode. The method also includes the step of applying a voltage across the surface and the electrode to machine the work-piece to generate a current. The method also includes the step of adding a first predetermined material to the flow of electrolyte to bind to the surface of the work-piece and leave a protective layer.

### BRIEF DESCRIPTION OF THE DRAWINGS

Advantages of the present invention will become more readily appreciated when considered in connection with the following detailed description and appended drawings, wherein:

FIG. 1 is a schematic diagram of the exemplary embodiment of the invention; and

FIG. 2 is a simplified flow diagram of the exemplary embodiment of the invention.

### DETAILED DESCRIPTION OF THE PREFERRED EMBODIMENT

The invention provides a method for machining a work-piece 10. The method includes the step of disposing a surface 12 of the work-piece 10 and an electrode 14 a predetermined distance apart. The method also includes the step of directing a flow of electrolyte 16 between the surface 12 and the electrode 14. The method also includes the step of applying a voltage across the surface 12 and the electrode 14 to machine the work-piece 10 to generate a current. The method also includes the step of adding a first predetermined material 18 to the flow of electrolyte 16 to bind to the surface 12 of the work-piece 10 and leave a protective layer.

The predetermined distance apart can be any distance providing desired results. In the exemplary embodiments of the invention, the predetermined distance is 500 microns or 1200 hundred microns. The flow rate of the electrolyte 16 can be any flow rate providing desired results. In the exemplary embodiments of the invention, electrolyte 16 flows past the surface at 6 meters per sec. The voltage applied across the surface 12 and the electrode 14 can be any voltage providing desired results. In the exemplary embodiments of the invention, the voltage applied across the surface 12 and the electrode 14 generates a current density of approximately 0.4 amps per square millimeter.

The exemplary first predetermined material 18 binds to the surface 12 of the work-piece 10 through molecular self-assembly. The ECM process strips away material to present a “fresh” surface 12 and the first predetermined material 18 reacts to locations on the fresh surface 12, building assemblies of molecules like hairs or bristles standing on end, at an angle, or lying flat on a surface. The first predetermined material 18 forms a protective layer on the surface 12 that enhance tribological properties of the surface 12. Tribology is the science of the mechanisms of friction, lubrication, and wear of interacting surfaces that are in relative motion. Tribology is a branch of engineering that deals with the design of parts to limit friction and wear. The enhancing of tribological properties refers to the fact that the surface 12 will experience less friction and less wear in operation after the ECM process of the invention is performed.

Any material that enhances the tribological properties of the surface 12 can be added to the electrolyte 16. In the exemplary embodiments of the invention, the predetermined material is selected from sodium stearate, zonyl FSP, zonyl FSN, TPS32 DDP, and stearic acid. Zonyl FSP and Zonyl FSN can be acquired from DuPont. TPS32 DDP is di-tertiary dodecyl polysulfide and can be acquired from Atofina Chemicals Inc. Any material operably similar the materials listed above can be used to practice the invention. A material is operably similar to the materials listed above if the material enhances the tribological properties of the surface 12 when added to the electrolyte 16.

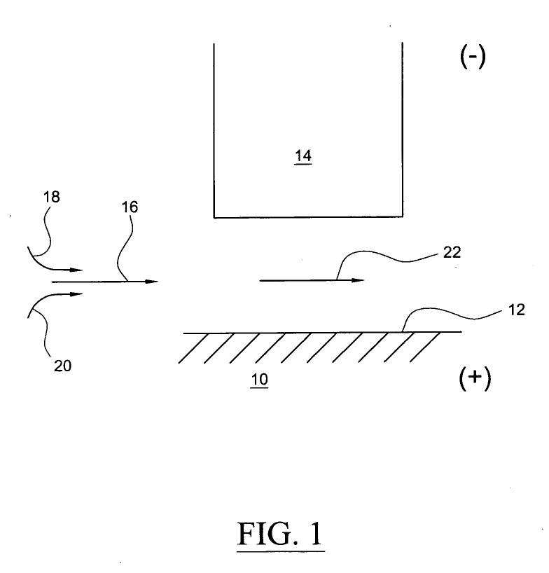

An exemplary embodiment of the invention can include the step of adding a second predetermined material 20 to the flow of electrolyte 16 to emulsify the first predetermined material 18 in the electrolyte 16. As best shown in FIG. 1, a combined flow 22 of the electrolyte 16, the first predetermined material 18, and the second predetermined material 20 flows between the electrode 14 and the surface 12. Any emulsifier can used to practice the invention. The emulsifier can be chosen in view of the first predetermined material to enhance the formation of the protective layer on the surface 12.

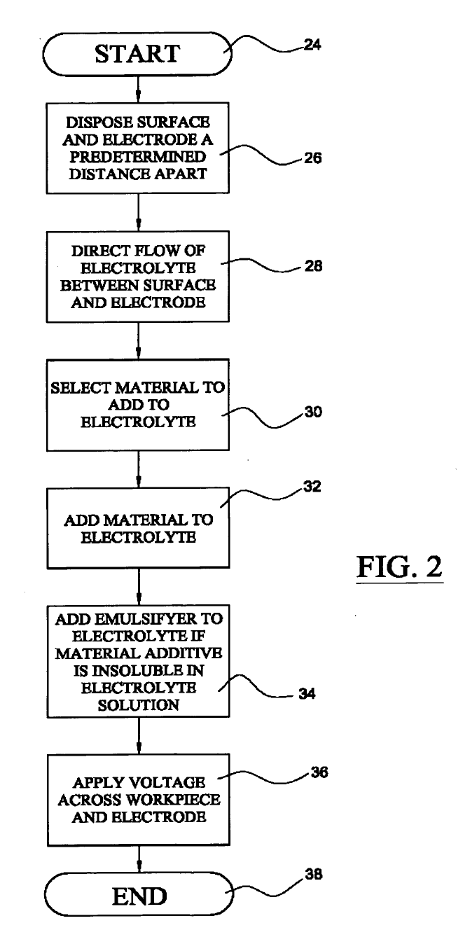

FIG. 2 provides a simplified flow diagram of an exemplary process. The process starts at step 24. At step 26, the surface 12 and the electrode 14 are disposed a predetermined distance apart. At step 28, a flow of electrolyte 16 is directed between the surface 12 and the electrode 14. At step 30, the first predetermined material 18 is selected. Step 30 can occur before step 28 in alternative embodiments of the invention. At step 32, the selected, first predetermined material 18 is added to the flow of electrolyte 16. Step 32 can occur before step 28 in alternative embodiments of the invention. At step 34, an emulsifier is added to the electrolyte 16. Step 34 can occur before step 28 in alternative embodiments of the invention. At step 36, voltage is applied across the surface 12 and the electrode 14 to generate a current and to machine the work-piece 10. The process ends at step 38.

The following paragraphs set forth exemplary embodiments of the invention:

Example 1—An 8% NaNO3 electrolyte with 0.1% sodium stearate and an emulsifier was directed between a surface and an electrode spaced from one another by a 500 micron gap. Subsequent wear testing revealed a specific mean wear rate of 1.12×10⁻¹⁷ m³/Nm. Wear testing of a surface treated with just electrolyte revealed a specific mean wear rate of 3.05×10⁻¹⁷ m³/Nm.

Example 2—An 8% NaNO3 electrolyte with 0.1% zonyl FSP was directed between a surface and an electrode spaced from one another by 1200 micron gap. Subsequent wear testing revealed a specific mean wear rate of 2.3×10⁻¹⁷ m³/Nm. Wear testing of a surface treated with just electrolyte revealed a specific mean wear rate of 3.05×10⁻¹⁷ m³/Nm.

Example 3—An 8% NaNO3 electrolyte with 0.1% zonyl FSN was directed between a surface and an electrode spaced from one another by 1200 micron gap. Subsequent wear testing revealed a specific mean wear rate of 2.3×10⁻¹⁷ m³/Nm. Wear testing of a surface treated with just electrolyte revealed a specific mean wear rate of 3.05×10⁻¹⁷ m³/Nm.

Example 4—An 8% NaNO3 electrolyte with 0.1% TPS32 DDP was directed between a surface and an electrode spaced from one another by 500 micron gap. Subsequent wear testing revealed a specific mean wear rate of 2.55×10⁻¹⁷ m³/Nm. Wear testing of a surface treated with just electrolyte revealed a specific mean wear rate of 3.05×10⁻¹⁷ m³/Nm.

Example 5—An 8% NaNO3 electrolyte with 0.1% stearic acid and 0.1% emulsifier was directed between a surface and an electrode spaced from one another by 500 micron gap. Subsequent wear testing revealed a specific mean wear rate of 2.9×10⁻¹⁷ m³/Nm. Wear testing of a surface treated with just electrolyte revealed a specific mean wear rate of 3.05×10⁻¹⁷ m³/Nm.

Many modifications and variations of the present invention are possible in light of the above teachings. It is, therefore, to be understood that within the scope of the appended claims, the invention may be practiced otherwise than as specifically described.

What is claimed is:

1. A method for machining a work-piece comprising the steps of:
disposing a surface of a work-piece and an electrode a predetermined distance apart;
directing a flow of electrolyte between the surface and the electrode;
applying a voltage across the surface and the electrode to machine the work-piece to generate a current; and
adding a first predetermined material to the flow of electrolyte to bind to the surface of the work-piece and leave a protective layer.

2. The method of claim 1 wherein said adding step is further defined as:
adding the first predetermined material to the flow of electrolyte to bind to the surface of the work-piece through molecular self-assembly and leave a protective layer.

3. The method of claim 1 wherein said adding step is further defined as:
adding the first predetermined material to the flow of electrolyte to bind to the surface of the work-piece and leave a protective layer enhancing tribological properties of the surface.

4. The method of claim 1 further comprising the step of:
selecting the first predetermined material from sodium stearate, zonyl FSP, zonyl FSN, TPS32 DDP, and stearic acid.

5. The method of claim 1 further comprising the step of:
adding a second predetermined material to the flow of electrolyte to emulsify the first predetermined material in the electrolyte.

6. The method of claim 1 further comprising the steps of:
selecting sodium stearate as the predetermined material; and
selecting five hundred microns as the predetermined distance.

7. The method of claim 6 further comprising the step of:
adding an emulsifier to the flow of electrolyte to emulsify the sodium stearate in the electrolyte.

8. The method of claim 1 further comprising the steps of:
selecting zonyl FSP as the predetermined material; and
selecting twelve hundred microns as the predetermined distance.

9. The method of claim 1 further comprising the steps of:
selecting zonyl FSN as the predetermined material; and
selecting twelve hundred microns as the predetermined distance.

10. The method of claim 1 further comprising the steps of:
selecting TPS32 DDP as the predetermined material; and
selecting five hundred microns as the predetermined distance.

11. The method of claim 1 further comprising the steps of:
selecting stearic acid as the predetermined material; and
selecting five hundred microns as the predetermined distance.

12. The method of claim 11 further comprising the step of:
adding an emulsifier to the flow of electrolyte to emulsify the stearic acid in the electrolyte.
